(19) United States
(12) Patent Application Publication
(10) Pub. No.: US 2016/0338889 A1
(43) Pub. Date: Nov. 24, 2016

(54) TRUNK SUPPORT CUSHION

(71) Applicant: YUKI TRADING CO., LTD., Taito-ku (JP)

(72) Inventor: Takafumi IZUTSU, Saitama (JP)

(73) Assignee: YUKI TRADING CO., LTD., Taito-ku (JP)

(21) Appl. No.: 14/891,759

(22) PCT Filed: Feb. 7, 2014
(86) PCT No.: PCT/JP2014/000662

§ 371 Date: Nov. 17, 2015

(51) Int. Cl. A61G 5/10; A47C 7/42

(52) U.S. Cl. CPC A61G 5/1043; A47C 7/425; A61G 2005/1048

(57) ABSTRACT

Provided is a torso support cushion capable of torso support and whereby the problem of the torso tilting to a paralyzed side or the pelvis tilting backwards does not occur when a person having paraplegia operates a hand rim in order to cause a wheelchair to move. A cushion arranged in a seat base of the wheelchair or chair comprises: a first cushion section positioned on the front surface of a backrest; and second and third cushion sections connected to both left and right sides of the first cushion section and positioned on inside surfaces in the vicinity of armrests. The first cushion section is fixed to the backrest section by the action of a tensile force from a belt, etc., being a first attachment member that causes same to come in contact with the backrest. The second and third cushion sections are fixed to a frame or support columns to which the armrests are fixed, by the action of a tensile force acting towards the front from second and third attachment members that form a belt shape, etc., extending towards the front form the front end sections of the second and third cushion sections, and by the action of a torsional force acting on the first cushion section towards the front, via the second and third cushion sections.

### TECHNICAL FIELD

The present invention relates to a trunk support cushion applied particularly to a seat of a wheelchair to provide a remarkable trunk support effect. The inventive cushion is naturally applicable to a chair other than the seats of wheelchairs. The trunk in this case refers to a human torso (from the shoulders to near the waist)

### BACKGROUND ART

It is known that, for example, if a user of a wheelchair is paralyzed on the one side of the trunk with respect to the spine, the trunk tilts toward the paralyzed side and causes trouble in operation of the wheelchair.

The paralysis leading to the tilt of the trunk during sitting results in a backward inclination of the pelvis in a sitting posture, provoking a pain in the lower back etc., and therefore often causes trouble in daily life such as refraining from going outside on a wheelchair.

A sitting position retaining cushion applied to a wheelchair for the purpose of stabilizing a sitting position is conventionally proposed in Patent Document 1 etc. The cushion of Document 1 is simply placed on a seat of a wheelchair with an outer surface of the cushion only brought into contact with a back surface and left and right side surfaces of the waist of a seated person and therefore cannot properly and sufficiently support the trunk of the seated person. Particularly, when a seated person paralyzed on one side of the body rolls the wheelchair (operates a hand rim with his/her own hand to move by him/herself), the tilting trunk cannot sufficiently be supported.

Although waist supporting forms called lumbar supports are conventionally known in office chairs and seats of passenger vehicles from Patent Document 2 etc., these supports cannot stably support the trunk of the person paralyzed on one side of the body and having the trunk tending to tilt.

### PRIOR ART DOCUMENT

### Patent Documents

Patent Document 1: Japanese Laid-Open Patent Publication No. 2003-153764

Patent Document 2: Japanese Patent No. 4456265

### SUMMARY OF THE INVENTION

### Problem to be Solved by the Invention

It is therefore a problem of the present invention to provide a trunk support cushion usefully applied to a chair to enable trunk support by making it possible to support the trunk of a person seated on a chair such as a wheelchair and an office chair in an unconventional novel form without conventionally known trouble and disadvantage that the trunk tilts toward the paralyzed side or the pelvis inclines backward when a person paralyzed on one side of the body operates a hand rim for moving a wheel chair.

### Means for Solving Problem

A configuration of an inventive trunk support cushion implemented for the purpose of solving the problem provides a cushion disposed on a seat (a seat portion formed of a seat surface, a backrest, and elbow rests of a chair) of a wheelchair or a chair (hereinafter collectively referred to as a “chair”), comprising a first cushion portion positioned on a front surface of the backrest; and second and third cushion portions connected to left and right respective side portions of the first cushion portion and positioned on inner side surfaces in the vicinity of the elbow rests, the cushion being formed such that the first cushion portion is fixed to the backrest side by causing a first attachment member such as a belt to apply a tension force (or a contact force to the backrest) bringing the first cushion into contact with the backrest and that the second and third cushion portions are fixed to frames or support posts provided with the elbow rests by causing second and third attachment members forming a belt shape extending forward from front end portions thereof to apply a forward tension force to the second and third cushion portions while applying a forward tension force via the second and third cushion portions to the first cushion portion.

The inventive cushion described above is formed by individually molding cushion members of the first to third cushion portions from a foam such as a urethane resin and covering the molded cushion members with an outer cover made of a flexible sheet material such as cloth and cowhide. This formation may be performed arbitrarily in terms of whether the left and right respective end portions of the first cushion portion and the second and third cushion portions are formed as an integrally-shaped foam body or the cushion portions are formed as individual foam bodies. In the case of the individual foam bodies, boundary portions between the first cushion and the second/third cushion portions are formed of the outer cover and the cushion is freely foldable at the boundary portions.

With regard to the inventive cushion having the configuration, when a person sits on the seat of the chair with the back of the person placed on the first cushion portion and directly leans the trunk thereon, the first cushion portion is somewhat pushed against the backrest by the trunk and is somewhat moved slightly backward. The movement of the first cushion portion somewhat moved backward acts to pull backward the rear end sides of the second and third cushion portions connected to the left and right side ends of the first cushion portion. Since the second and third cushion portions with the rear end sides pulled backward has the front end portions thereof pulled forward by the second and third attachment members and fixed to the frames etc., of the elbow rests, the second and third cushion portions are put into a tensely stretched state and located inside the vicinity of the elbow rests of the seat by the action of pulling the rear end sides backward via the first cushion portion and the fixing action of pulling the front end sides forward. As a result, the trunk of the seated person is supported such that the body side surfaces are held from the left and right with the second and third cushion portions. In other words, this can be compared to a feeling of a seated person rolling a wheelchair as if a caretaker directly facing the person holds the left and right body side surfaces of this seated person with hands of the both arms of the caretaker.

### Effect of the Invention

As described above, since the first cushion portion positioned on the front surface of the backrest is attached by causing the first attachment member such as a belt to apply the force bringing the first cushion portion into contact with the backrest and the second and third cushion portions positioned inside the vicinity of the left and right elbow rests are fixed to the frames etc. of the elbow rests while being pulled forward by the second and third attachment members forming a belt shape etc. extending forward from the front end portions thereof, when a person is seated leaning the trunk on the first cushion portion, the second and third cushion portions are pulled backward and forward and put into a tensely stretched state and, therefore, the inventive trunk support cushion can give support to hold the body side surfaces of the trunk of the seated person from left and right with the second and third cushion portions. Thus, for example, even when a seated person paralyzed on one side of the body rolls a wheelchair to move by him/herself and the body weight is applied to the second or third cushion portion because the trunk tilts, since the second or third cushion portion is supported by being pulled from the front and back, the position of the cushion is not displaced due to a force from the tilting trunk and the support force is not weakened.

### BRIEF DESCRIPTION OF DRAWINGS

FIG. 1 is a partially omitted front view of an example of an inventive trunk support cushion.

FIG. 2 is a plane view of the inventive trunk support cushion of FIG. 1.

FIG. 3 is a perspective view of the inventive trunk support cushion of FIGS. 1 and 2.

FIG. 4 is a perspective view of an example of a state of the inventive cushion of FIGS. 1 to 3 mounted on a wheelchair.

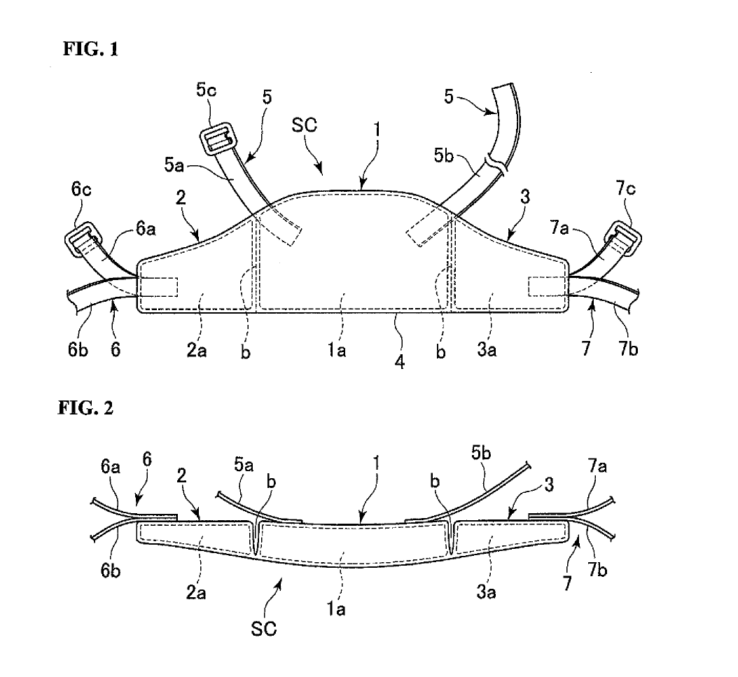

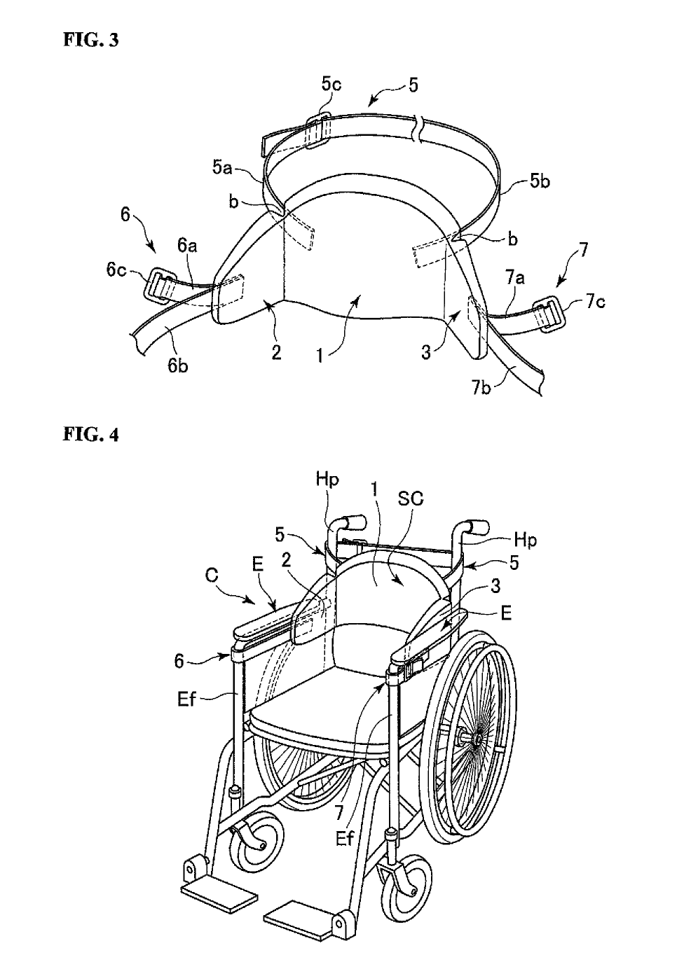

### MODE FOR CARRYING OUT THE INVENTION

In the figures, an example of an inventive trunk support cushion SC has a first cushion portion 1 positioned on a front surface of a backrest of a chair and a second cushion portion 2 and a third cushion portion 3 coupled to and extending outward from left and right end portions of the cushion portion 1 formed as cushion members. The second and third cushion portions 2, 3 are arranged inside the vicinity of elbow rests of a seat.

Cushion members 1a, 2a, 3a loaded inside the cushion portions 1 to 3 are formed of flexible foam molded bodies made of an appropriate synthetic resin material such as a urethane-based resin by way of example, and these cushion members 1a to 3a are covered by an outer cover 4 that is a flexible planar member such as cloth made of woven or nonwoven fabrics, leather, and a synthetic resin sheet, and are thereby formed into the trunk support cushion SC of the present invention.

Although the cushion members 1a to 3a are individually molded, the three cushion members 1a to 3a may integrally be molded into one cushion member. Even in this case, the one cushion member is covered by the outer cover 4 to define left and right portions thereof as the second and third cushion portions 2, 3 and an intermediate portion between the both portions 2, 3 as the first cushion portion 1.

The foam bodies of the cushion members 1a to 3a may have either single-layer structure or multilayer structure regardless of whether individually molded products or integrally molded products. Alternatively, the cushion members 1a to 3a and the outer cover 4 may be formed as an integrally molded product of a synthetic resin material and used as the cushion portions 1 to 3 of the present invention. The cushion members can be achieved by using not only the foam bodies of the example but also a substance and a material providing a cushion action such as a gel-like substance and a gas such as air.

Although not depicted, the cushion portions 1 to 3 in the present invention maybe achieved by using, for example, those formed of belt-like or band-like bodies that have a wide width (a width corresponding to a vertical width of the depicted cushion portions 1 to 3) and that are preferably thick as the cushion portions 1 to 3 in some cases.

In the depicted example, the first to third cushion portions 1 to 3 are formed such that the height of boundary portions b of the second and third cushion portions 2, 3 with the first cushion portion 1 is on the same level as the height of the left and right outer ends of the first cushion portion 1. In the present invention, the shapes, sizes, etc. of the cushion portions 1 to 3 are not limited to the depicted example.

The cushion portions 1 to 3 are disposed with a first attachment member 5 for attaching the first cushion portion 1 close to a backrest B of a chair C of a wheelchair etc., and are also disposed with second and third attachment members 6, 7 for positioning and attaching the second and third cushion portions to the inside of the vicinities of left and right elbow rests E of the chair C.

The first attachment member 5 is formed of two belts 5a and 5b attached to the vicinities of the left and right side ends on a rear surface (back surface) of the first cushion portion 1 in the depicted example so as to act as a force bringing the first cushion portion 1 into contact with the front surface side of the backrest B of the chair C (a backward tension force). The one belt 5a is disposed with a fixing buckle 5c restricting or fastening and fixing the other belt 5b.

The first cushion portion 1 is fixed by putting the belts 5a, 5b around the back surface of the backrest B of the chair C and passing and fixing the belt 5b through the buckle Sc of the belt 5a so as to hold the backrest B in this posture. As a result, the first cushion portion 1 is positioned on the front surface of the backrest B while being subjected to a force bringing the cushion portion into contact with the front surface of the backrest B (i.e., a tension force pulling the cushion portion closer to the backrest front surface) by the two belts 5a and 5b put around the back surface of the backrest B.

In such a state, the second and third cushion portions 2, 3 are connected at the boundary portions b via the outer cover 4 to the first cushion portion 1 disposed on the front surface of the backrest B by the first attachment member 5 and are disposed with second and third attachment members 6, 7 formed of belts at respective front end portions.

Since the second and third attachment members 6, 7 have the same structure and form, the second attachment member 6 will hereinafter be described.

The attachment member 6 is formed of two belts 6a and 6b in the depicted example for positioning the second cushion portion 2 inside the vicinity of the elbow rest E and fixing the second cushion portion 2 to a support post or a frame Ef of the elbow rest E under the action of a forward tension force. Also in the attachment member 6, the belt 6a is disposed with a buckle 6c for fixing the belt 6b, and the belt 6b hooked around the elbow rest frame Ef is tightened to fasten the frame Ef and is passed through the buckle 6c and integrated with the belt 6a.

The third attachment member 7 has the same structure as the attachment member 6 and is formed of two belts 7a, 7b and a fixing buckle 7c disposed on the belt 7a.

In the present invention, the attachment members 5 to 7 for supporting the first to third cushion portions 1 to 3 to the seat are not limited to the belts 5a, 5b, the belts 6a, 6b, and the belts 7a, 7b of the example 9. For example, a string-like body or a chain-like body made of cloth or leather can be used in addition to the belts 5a to 7b described above, and a coupling means such as a connector connecting and coupling strings or chains to each other can be used instead of the buckles 5c to 7c. A hook-and-loop fastener can also be used for connecting and coupling the belts and strings.

The inventive trunk support cushion SC formed as described above is set and used in the seat of the wheelchair C as exemplarily illustrated in FIG. 4. At the time of setting, the first cushion portion 1 and the second and third cushion portions on the left and right are bent at the boundary portions b into an approximately U-shape corresponding to a plane shape of the seat and placed on the seat, and the left and right belts 5a, 5b of the first cushion portion 1 are hooked around and fixed to handle support posts Hp of the wheelchair.

FIG. 4 depicts a form in which the left and right of the back surface of the first cushion portion 1 are respectively hooked around and fixed to the handle support posts Hp of the handle Hp by the respective belts 5a and 5b. Therefore, the belts attached to the left and right of the back surface of the first cushion portion 1 may be formed such that each belt is formed of the belt 5a having the fixing buckle 5c and the belt 5b coupled to the belt 5a as is the case with the attachment members 6, 7 of the second and third cushion portions.

When the first cushion portion 1 is set to the backrest of the chair by the first attachment member 5 while being subjected to the backward tension force, the second and third cushion portions positioned to the seat in the posture extending forward from the left and right of the first cushion portion 1 are supported while causing the respective attachment members 6, 7 to apply a tension force to the frames Ef provided with the elbow rests E. In particular, in the example of FIG. 4, with regard to the second and third cushion portions 2, 3 on the left and right, the belts 6b, 7b forming the respective attachment members 6, 7 are hooked around the frames Ef in a vertical posture to keep the respective cushion portions 2, 3 pulled forward, and the belts 6b, 7b are fixed through the buckles 6c, 7c of the belt 6a, 7a and thereby located under the elbow rests E while being subjected to a tension force toward the front side of the chair C.

In this case, since the second and third cushion portions 2, 3 have the respective rear end sides connected via the boundary portions b to the first cushion portion 1 disposed on the front surface of the backrest B with the backward force applied thereto, the both end portions of the cushion portions are subjected to the forward and backward tension forces and are disposed in a tensely stretched form.

When a person sits on the seat of the wheelchair C including the inventive support cushion SC disposed as described above and leans the trunk on the first cushion portion 1, the left and right cushion portions 2, 3 connected to the first cushion portion 1 are subjected to a backward pulling force integrally with the first cushion portion while the left and right cushion portions 2, 3 are pulled forward and fixed by the attachment members 6, 7 and, therefore, the cushion portions 2, 3 are retained in a tensely stretched state with the tension force acting thereon from the front and rear.

As a result, even if a seated person has hemiplegia and the trunk may tilt on the paralyzed side, the tensely stretched second or third cushion portion 2 or 3 tightly support the tilt without causing the trouble that the cushion portions moves or deforms and becomes effectively unable to give support as in the case of conventional products.

In the inventive support cushion SC, the first cushion portion 1 on the backrest B is pulled backward on the left and right of the back surface by the attachment member 5 while the left and right of the front surface of this cushion portion 1 are pulled forward by the respective attachment members 6, 7 of the second and third cushion portions 2, 3 on the left and right connected via the boundary portions b and, therefore, the cushion portion 1 can support the waist spine leading to the pelvis of a seated person such that the waist spine is slightly pushed forward, thereby providing the trunk support effect unachievable by the conventional support mechanisms and cushion materials. Although the example of applying the inventive support cushion SC to a wheelchair is described above, the inventive cushion is naturally applicable to various chairs having a seat such as office chairs and vehicle chairs.

### INDUSTRIAL APPLICABILITY

The present invention is as described above and can be applied to any chairs having a seat including wheelchairs to achieve a support form that is not provided by the conventional support mechanisms

### EXPLANATIONS OF LETTERS OR NUMERALS

1 first cushion portion
2 second cushion portion
3 third cushion portion
1a to 3a cushion member
4 outer cover
5 first attachment member
6 second attachment member
7 third attachment member

1. A trunk support cushion disposed on a seat of a wheelchair or a chair, comprising: a first cushion portion positioned on a front surface of a backrest; and second and third cushion portions connected to left and right respective side portions of the first cushion portion and positioned on inner side surfaces in the vicinity of elbow rests, the cushion being formed such that the first cushion portion is fixed to the backrest side by causing a first attachment member such as a belt to apply a tension force bringing the first cushion into contact with the backrest and that the second and third cushion portions are fixed to frames or support posts provided with the elbow rests by causing second and third attachment members forming a belt shape extending forward from front end portions thereof to apply a forward tension force to the second and third cushion portions while applying a forward tension force via the second and third cushion portions to the first cushion portion.

2. The trunk support cushion of claim 1, wherein the cushion portions are formed by covering cushion members in respectively independent forms or a cushion member in a form of integrally molding of the cushion members with a flexible planar member such as cloth or are formed of belt-like or band-like members that have a wide width and that are preferably thick.

3. The trunk support cushion of claim 1, wherein the backward tension force applied to the first cushion portion is formed by fixing to the backrest side of the first attachment member disposed to act on a back surface of the cushion portion.

4. The trunk support cushion of claim 1, wherein the second and third attachment members are disposed on the second and third cushion portions such that the forward tension force is applied through the second and third cushion portions to a front surface side of the first cushion portion.

5. The trunk support cushion of claim 2, wherein the backward tension force applied to the first cushion portion is formed by fixing to the backrest side of the first attachment member disposed to act on a back surface of the cushion portion.

6. The trunk support cushion of claim 2, wherein the second and third attachment members are disposed on the second and third cushion portions such that the forward tension force is applied through the second and third cushion portions to a front surface side of the first cushion portion.

7. The trunk support cushion of claim 3, wherein the second and third attachment members are disposed on the second and third cushion portions such that the forward tension force is applied through the second and third cushion portions to a front surface side of the first cushion portion.

8. The trunk support cushion of claim 5, wherein the second and third attachment members are disposed on the second and third cushion portions such that the forward tension force is applied through the second and third cushion portions to a front surface side of the first cushion portion.
